(19) United States
(12) Patent Application Publication
(10) Pub. No.: US 2014/0093263 A1
(43) Pub. Date: Apr. 3, 2014

(54) System and Method for Controlling Multiple Light Sources of a Laser Scanning System in an Imaging Apparatus

(71) Applicant: LEXMARK INTERNATIONAL, INC., Lexington, KY (US)

(72) Inventors: Miles Anderson, Georgetown, KY (US); Matthew Brandon Ballenger, Lexington, KY (US); David John Mickan, Lexington, KY (US); Kevin Dean Schoedinger, Lexington, KY (US); Steven A. Seng, Lexington, KY (US)

(73) Assignee: Lexmark International, Inc., Lexington, KY (US)

(21) Appl. No.: 13/853,586

(22) Filed: Mar. 29, 2013

Related U.S. Application Data
(60) Provisional application No. 61/707,460, filed on Sep. 28, 2012.

(51) Int. Cl. G03G 15/043

(52) U.S. Cl. CPC G03G 15/043
USPC 399/51

(57) ABSTRACT

An imaging device having a printhead unit which includes a plurality of independently controllable light sources, each light source generating a light beam when activated; a photoconductive surface operable at a plurality of image transfer rates; a scanning device having one or more deflecting surfaces, the scanning device arranged to direct the light beams so as to sweep in at least one scan direction across a surface such that, for each sweep, scan lines written by the light beams are spaced from one another on the photoconductive surface in a process direction that is nominally orthogonal to the scan direction; and a controller configured to selectively activate any number of the light sources for use during a print operation to write image data along scan lines on the photoconductive surface, wherein a rotational velocity of the scanning device is selected and the number of the light sources activated based upon at least one selected operating parameter for the imaging device.

### CROSS REFERENCES TO RELATED APPLICATIONS

The present application is related to and claims priority from U.S. provisional application 61/707,460, filed Sep. 28, 2012, entitled, “System and Method for Selectively Controlling Multiple Light Sources of a Laser Scanning System in an Imaging Apparatus,” the content of which is hereby incorporated by reference herein it is entirety.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Disclosure

The present disclosure relates in general to electrophotographic devices, and more particularly, to electrophotographic devices that support a wide range of image transfer rates and methods of operating same.

2. Description of the Related Art

In electrophotography, a latent image is created on the surface of an electrostatically charged photoconductive surface, e.g., a drum or belt, by exposing select portions of the photoconductive surface to laser light. Essentially, the density of the electrostatic charge on the photoconductive surface is altered in areas exposed to a laser beam relative to those areas unexposed to the laser beam. The latent electrostatic image thus created is developed into a visible image by exposing the photoconductive surface to toner, which typically contains pigment components and thermoplastic components. When so exposed, the toner is attracted to the photoconductive surface in a manner that corresponds to the electrostatic density altered by the laser beam. The toner is subsequently transferred from the photoconductive surface to a print medium such as paper, either directly or by using an intermediate transfer device. A fuser then applies heat and pressure to the print medium. The heat causes constituents including the thermoplastic components of the toner to flow into the interstices between the fibers of the medium and the fuser pressure promotes settling of the toner constituents in these voids. As the toner is cooled, it solidifies and adheres the image to the medium.

In a typical laser scanning system, a faceted rotating polygon mirror is used to sweep a laser beam across a photoconductive surface in a scan direction while the photoconductive surface advances in a process direction that is orthogonal to the scan direction. The polygon mirror speed is synchronized with the advancement of the photoconductive surface so as to achieve a desired image resolution, typically expressed in dots per inch (dpi) at a given image transfer rate, typically expressed in pages per minute (ppm). Thus, for example, to achieve a resolution of 600 dots per inch in the process direction at an image transfer rate of 55 pages per minute, the photoconductive surface is operated at a speed sufficient to transfer toner images to 55 pages in one minute of time. Moreover, the polygon mirror velocity is configured to perform 600 scans across the photoconductive surface in the time it takes for the photoconductive surface to advance one inch.

Slowing the operation of the photoconductive surface relative to a normal (full speed) operating image transfer rate can be desirable under certain circumstances. For example, slowing the photoconductive surface to one half of the full speed image transfer rate can provide double scan line addressability which, ideally, can improve the quality or resolution of the image printed on the medium. Additionally, by operating the photoconductive surface at half speed, greater time is available for fusing operations because the print medium is moving through the device at a slower speed. Relatively longer fusing times are desirable for example, when the print medium is relatively thick or where transparencies are used.

In an electrophotographic system, the motor which is typically utilized to rotate the polygon mirror is a fluid bearing motor. Fluid bearing motors have a finite range of operation. For example, below approximately 18 k rpm, fluid bearing motors are seen to cause jitter in the printed image. As a result, the nominal range for the motors is between about 18 k and about 38.5 k rpm.

In order to achieve higher printer processing speeds, one approach is to increase the number of facets on the motor up to around 12. However, that could potentially cause difficulty in the optical design due to scan efficiency limitations. Another approach is to increase the number of diodes in the laser scanning system, resulting in writing multiple scan lines on each scan. With the capability to reach higher printer processing speeds, there is an increasing challenge for meeting all possible operating points for the electrophotographic system.

### SUMMARY

Example embodiments provide a significant improvement over existing imaging systems by selecting any number of laser beams for use in a print operation. In particular, the imaging system includes a plurality of independently controllable light sources, each light source generating a light beam when activated; a photoconductive surface operable at a plurality of image transfer rates; a scanning device having one or more deflecting surfaces, the scanning device arranged to direct the light beams so as to sweep in at least one scan direction across a surface such that, for each sweep, scan lines written by the light beams are spaced from one another on the photoconductive surface in a process direction that is nominally orthogonal to the scan direction; and a controller configured to selectively activate any number of the light sources for use during a print operation to write image data along scan lines on the photoconductive surface, wherein a rotational velocity of the scanning device is selected and the number of the light sources activated based upon at least one selected operating parameter for the imaging device.

In an example embodiment, the at least one selected operating parameter is a selection of a darkness for the print operation. In another embodiment, the at least one selected operating parameter is a noise level setting of the imaging device during the print operation. In yet another embodiment, the at least one operating parameter is a time to first print setting for the imaging device.

### BRIEF DESCRIPTION OF THE DRAWINGS

The above-mentioned and other features and advantages of the disclosed embodiments, and the manner of attaining them, will become more apparent and will be better understood by reference to the following description of the disclosed embodiments in conjunction with the accompanying drawings, wherein:

FIG. 1 is a side elevational view of an improved imaging device according to an example embodiment;

FIG. 2 is a block diagram depicting printhead units appearing in the imaging device of FIG. 1 according to an example embodiment;

FIGS. 3-5 are diagrams illustrating laser beam scan line impingement along the surface of a photoconductive member of FIG. 1 according to an example embodiment; and

FIG. 6 illustrates the variation in the number of light sources activated and the speed of the polygon mirror of the imaging device of FIG. 1 over a range of processing speeds according to an example embodiment.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

Terms such as “first”, “second”, and the like, are used to describe various elements, regions, sections, etc. and are not intended to be limiting. Further, the terms “a” and “an” herein do not denote a limitation of quantity, but rather denote the presence of at least one of the referenced item.

Furthermore, and as described in subsequent paragraphs, the specific configurations illustrated in the drawings are intended to exemplify embodiments of the disclosure and that other alternative configurations are possible.

Reference will now be made in detail to the example embodiments, as illustrated in the accompanying drawings. Whenever possible, the same reference numerals will be used throughout the drawings to refer to the same or like parts.

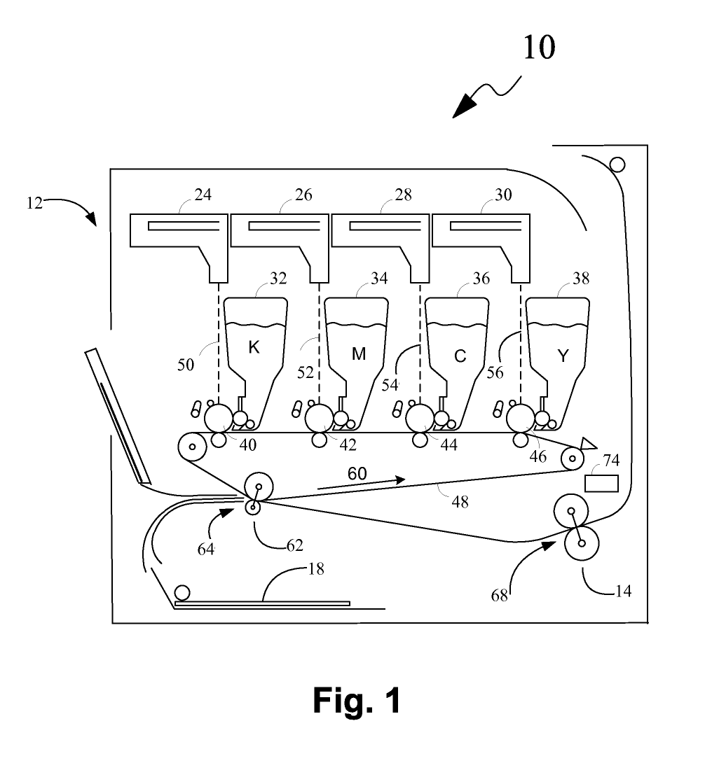

Referring now to the drawings, and particularly to FIG. 1, an electrophotographic device is illustrated in the form of a color laser printer 10. The printer 10 includes generally, an imaging section 12, a fuser assembly 14 and a paper path that moves a sheet of print media 18 through printer 10. Briefly, a sheet of print media 18 is transported along the paper path so as to pass the imaging section 12. At the imaging section 12, cyan, yellow, magenta and black toner patterns (CYMK) are registered to form a color toner image, which is transferred to the print media 18. The print media 18 then passes through the fuser assembly 14, which causes the toner patterns to adhere to the print media 18. After fusing, the print media 18 is transported outside the printer 10.

To form the overlaid toner patterns, the imaging section 12 includes four printhead units 24, 26, 28, 30, four toner cartridges 32, 34, 36, 38, four photoconductive drums 40, 42, 44, 46 and an intermediate transfer belt 48. Printhead unit 24 generates a plurality of independently controllable laser beams 50a-50n that are modulated in accordance with bitmap image data corresponding to the color image plane to form a latent image on the photoconductive drum 40. Similarly, printhead unit 26 generates independently controllable laser beams 52 that are modulated in accordance with bitmap image data corresponding to the magenta color image plane to form a latent image on the photoconductive drum 42. Printhead unit 28 generates independently controllable laser beams 54 that are modulated in accordance with bitmap image data corresponding to the cyan color image plane to form a latent image on the photoconductive drum 44. Similarly, Printhead unit 30 generates independently controllable laser beams 56 that are modulated in accordance with bitmap image data corresponding to the yellow color image plane to form a latent image on the photoconductive drum 46.

Each photoconductive drum 40, 42, 44, 46 continuously rotates clockwise such that toner is transferred to each photoconductive drum surface in a pattern corresponding to the latent image formed thereon by corresponding printhead unit 24, 26, 28, 30. Intermediate transfer belt 48 travels past each photoconductive drum 40, 42, 44, 46, as indicated by the directional arrow 60, the corresponding toner patterns are transferred to the outside surface of the intermediate transfer belt 48 for subsequent toner transfer to the sheet of print media 18.

It is understood that the photoconductive surfaces on which a latent image is formed is not limited to the photoconductive drums 40, 42, 44, 46 shown in FIG. 1, and may include, for example, photoconductive belts or other structures.

In an alternative embodiment, a media transport belt (not shown) is used instead of intermediate transfer belt 48 for moving the sheet of media 18 to the nips formed in part by photoconductive drums 40, 42, 44 and 46 for direct transfer of toner from the photoconductive drums to the sheet of media 18.

The timing of the laser scanning operations on each of the photoconductive drums 40, 42, 44, 46, the speed of intermediate transfer belt 48 and the timing of the travel of a sheet of media 18 along the paper path are coordinated such that a forward biased transfer roll 62 transfers the toner patterns from the intermediate transfer belt 48 to the print sheet of media 18 at a second transfer nip 64 so as to form a composite color toner image on the sheet of media 18.

The print media 18 is then passed through fuser assembly 14. Generally, heat and pressure are applied to the print media 18 as it passes through a fuser nip 68 of the fuser assembly 14 so as to adhere the color toner image to the print media 18. The print media 18 is then discharged from the printer 10 along a media discharge path.

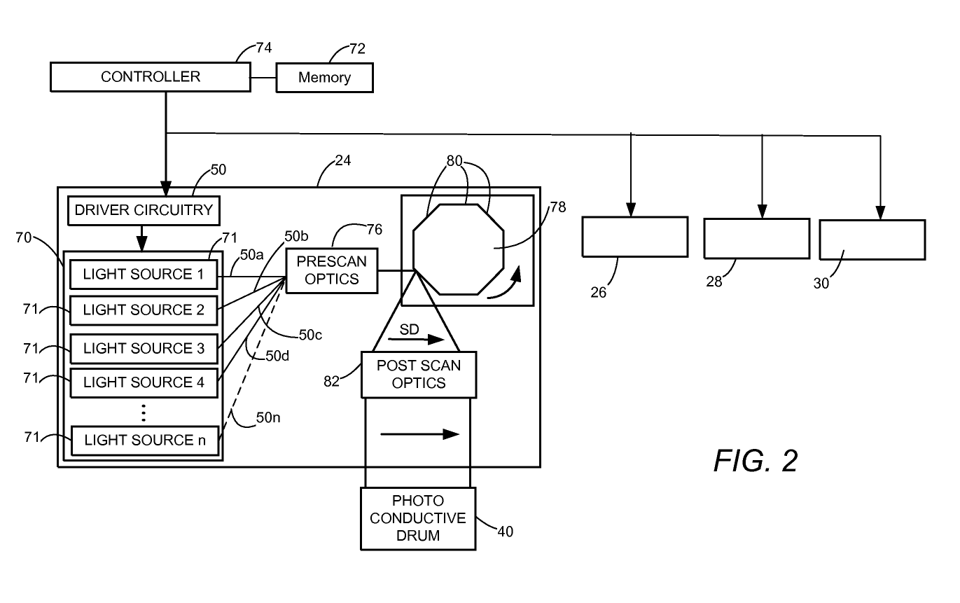

Referring now to FIG. 2, the printhead 24 includes laser sources 70, e.g., a plurality of laser diodes 71, each laser diode 71 generating an associated one of the laser beams 50a, 50b . . . 50n. For sake of clarity, the example embodiments will be generally described below in terms of four laser beams 50a-50d per photoconductive surface, i.e., n=4 for purposes of explanation. However, it is understood the number of laser beams is expandable to any reasonable number N of laser beams as indicated by the additional laser beam 50n in phantom lines. Further, the description of the example embodiments will largely be directed to printhead unit 24 and it is understood that such description will apply equally to each of the other printhead units 26, 28 and 30 which has a similar construction to printhead unit 24.

Laser diodes 71 may have any known or future laser diode architecture, such as a vertical cavity surface emitting laser (VCSEL) diode architecture. Though the example embodiments are described herein as utilizing a plurality of laser diodes 71, it is understood that components which generate light beams other than laser beams may be used instead of laser diodes 71.

A controller 74, e.g., a video processor or other suitable control logic, converts image data stored in memory 72 into a format suitable for imaging by the printhead 24. The converted image data is communicated to the printhead 24. The controller 74 may further designate whether each laser beam 50a-50d should be disabled or enabled to modulate image data for a particular print job as will be explained more fully herein. Each modulated laser beam 50a-50d passes through pre-scan optics 76, and is reflected off of a rotating scanning device, e.g., a polygon mirror 78. The polygon mirror 78 includes a plurality of deflecting surfaces, e.g., facets 80 (eight facets as shown) that reflect the laser beams 50a-50d through post scan optics 82 so as to sweep generally in a scan direction SD across the corresponding recording medium, e.g., the photoconductive drum 40.

Post scan optics 82 direct the laser beams 50a-50n from the printhead unit 24 so as to form scan lines on the photoconductive drum 40. The scan lines are spaced from one another in the process direction, which is generally orthogonal to the scan direction, by a beam scan spacing. That is, in a given sweep in which each laser beam 50a-50d is turned on or is otherwise modulated, the respective beams will be spaced from one another on the surface of photoconductive drum 40 in the process direction by the predetermined distance. This distance between beams defines a “beam scan spacing” for the beams 50a-50d in the process direction. In an example embodiment, the beam scan spacing for beams 50a-50n is about 42.33 microns, which corresponds to 600 dpi at a processing speed of 70 ppm and allows for 1200 dpi at a processing speed of 35 ppm, as discussed in greater detail below.

### Multiple Speed Operation

In general, the image transfer rate of printer 10 defines a speed at which a toner image is transferred from the surface of photoconductive drums 40, 42, 44 and 46 to intermediate transfer belt 48. Moreover, it is desirable in certain electrophotographic devices to provide several image transfer rates to support different modes of operation. Relatively slower image transfer rates generally result in the print media moving more slowly through the device, which may promote better fusing operations, e.g., to achieve translucence of color toners fused onto transparent media, improve adherence of toner when printing thick, gloss or specialty papers, or prevent fuser overheating. To this end, one approach is to slow down the image transfer rate by slowing down the intermediate transfer belt 48 and correspondingly slowing down the photoconductive drums 40, 42, 44, 46 and the associated transport of the print media 18. When slowing down the image transfer rate, either the laser output power, the rotational velocity of the polygon mirror, or both may be adjusted down in corresponding amounts to compensate for the new image transfer rate. As mentioned, relatively large variations in polygon motor velocity can also affect print quality, such as by causing jitter and otherwise unstable rotational velocity of the polygon mirror.

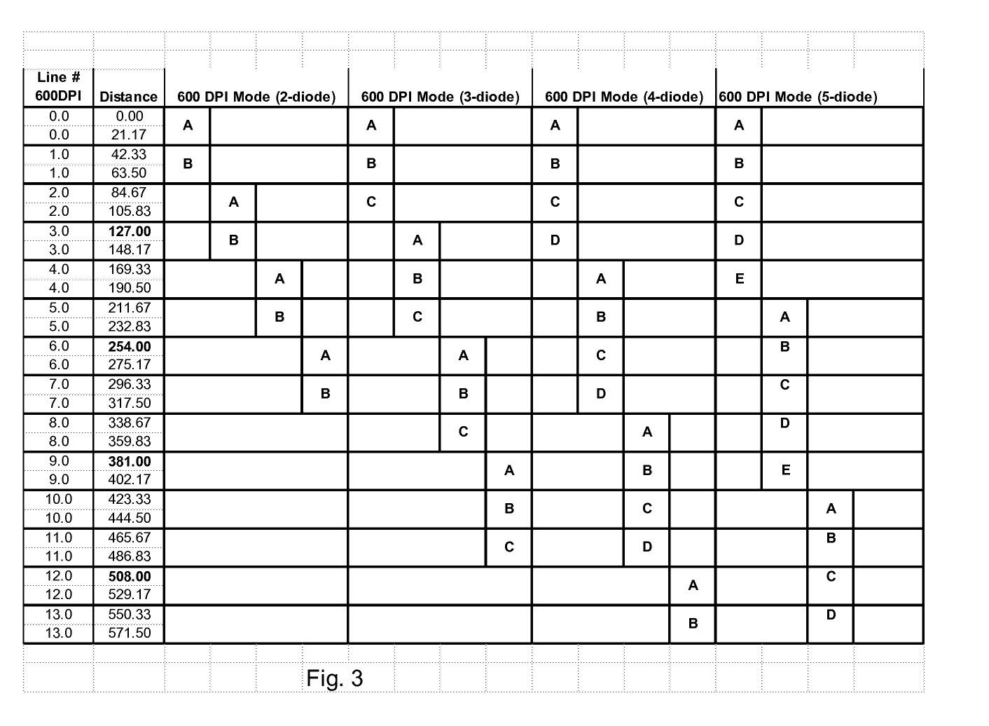

However, the speed of a brushless DC motor that is used to drive a photoconductive drum 40, 42, 44, 46 may be adjusted over a relatively wide range and still maintain a robust phase lock to maintain a relatively constant rotational velocity. As such, FIGS. 3-5 illustrate by way of illustration, and not by way of limitation, laser beam control for printhead unit 24 such that several speed modes can be realized.

Controller 74 controls the motor for polygon mirror 78 of each printhead unit 24, 26, 28, 30, the motor for rotating each photoconductive drum 40, 42, 44, 46, and laser diodes 71 appearing in each printhead unit so that printer 10 is able to print at several printing points. For example, controller 74 is configurable to print at low processing speeds, such as about 30 to about 40 ppm, more typical processing speeds, such as about 55 ppm to about 70 ppm, and high processing speeds, such as up to about 120 ppm. This relatively wide range of processing speeds may be accomplished while keeping the motor for polygon mirror 78 within a desired range between about 18 k rpm and about 38.5 k rpm to avoid instability and inducing jitter in the print output.

In an example embodiment, controller 74 individually activates laser diodes 71 of printhead unit 24 to provide for a wide range of printing performance. Specifically, during a print operation, each laser diode 71 may be activated to generate scan lines of image data that sweep across the surface of the photoconductive drum 40, or deactivated in which the deactivated laser diode(s) 71 will not contribute to creating a latent image on photoconductive drum 40 during the print operation. A laser diode 71 that is activated may remain activated during the entire print operation so that the laser beam generated thereby is deflected from each facet 80 of the polygon mirror 78 and swept onto the surface of photoconductor drum 40, or activated so that the laser beam is deflected from less than all facets 80. In an example embodiment, though, an activated laser diode 71 will not be deactivated and unused during a portion of the print operation corresponding to certain one or more facets 80 of the polygonal mirror 78. Controller 74 selects for activation any number of laser diodes 71, from one diode 71 to all diodes 71, for use in generating laser beams for sweeping across the surface of conductive drum 40 during a print operation.

In an example embodiment, for each printhead unit, controller 74 not only selects and activates a number of laser diodes 71 for a print operation, but also selects the speed for the motor of polygon mirror 78 as well as the speed of the motor for each of photoconductive drum 40. The speed of the motor for photoconductive drum 40, which corresponds to the processing speed of printer 10, may be based, for example, upon a user selection of media type or media size. Media type and size may affect fusing time and thus affect processing speed accordingly. The processing speed itself, and thus the speed of photoconductive drum 40, may also be selected by the user of printer 10. The processing speed may be user selected simply by allowing printer 10 to print at a default speed, such as 70 ppm. The number of laser diodes 71 activated for a printer operation may be selected by controller 74 so that the resulting speed of polygon mirror 78 is maintained within an acceptable range of speeds.

In this way, the selection of the number of laser diodes 71 to use for creating the latent image in a print operation may be viewed similar to a motor vehicle transmission. The vehicle's engine, in this analogy corresponding to the motor for rotating polygon mirror 78, has a limited range of operation but the vehicle, corresponding to printer 10, has a much wider range of operating speeds, corresponding to the wide range of processing speeds of printer 10. The motor vehicle's transmission is the mechanism that bridges the vehicle's engine's speed to the vehicle's speed, as the selection of laser diodes 71 serves to bridge or couple the speed of the motor for polygon mirror 78 to the processing speed of printer 10.

FIG. 3 illustrates the operation of printer 10 in four different operating modes in accordance with an example embodiment. Each operating mode illustrated utilizes a non-interlacing scheme for impinging the surface of photoconductive drum 40 with laser beams 50. Printer 10 prints an image at 600 dpi at each operating mode. Each operating mode illustrated includes up to four columns, with each column corresponding to a facet 80 of polygon mirror 78 which intercepts laser beams 50 and deflects same towards photoconductive drum 40. It is understood that polygon mirror 78 includes more than four facets 80, each of which intercepts laser beams 50a-50d and that only four facets 80 are shown for reasons of simplicity. The rows represent the process direction position of a laser scan sweep on the surface of photoconductive drum 40. As illustrated, the first laser beam 50a, designated beam A, is modulated in accordance with image data and deflected from every facet 80 of polygon mirror 78. Depending upon the number of diodes activated for the print operation, beam A will scan across the photoconductive drum surface every 84.67 microns for the two diode mode, every 127 microns for the three diode mode, every 169.33 microns for the four diode mode, and every 211.67 microns for the five diode mode.

Similarly, the second laser beam 50b, designated B, is modulated in accordance with image data corresponding to the facet resolution and is spaced about 42.33 microns from laser beam A from the same mirror facet, as described above. Third laser beam 50c, designated C, is modulated with image data and spaced about 42.33 microns from laser beam B from the same mirror facet, and fourth laser beam 50d, designated D, is modulated with image data and spaced about 42.33 microns from laser beam C from the same mirror facet. A fifth laser beam 50e, designated E, generated from a fifth laser diode 71 according to an embodiment including at least five laser diodes 71, is similarly modulated and spaced along the surface of the photoconductive drum about 42.33 microns from laser beam D. As can be seen in FIG. 3, activating a greater number of laser diodes 71 results in more scan lines impinging onto the surface of the photoconductive drum 40 with each mirror facet, thereby resulting in the print operation being completed faster than the time it takes for a print operation using a lesser number of diodes 71.

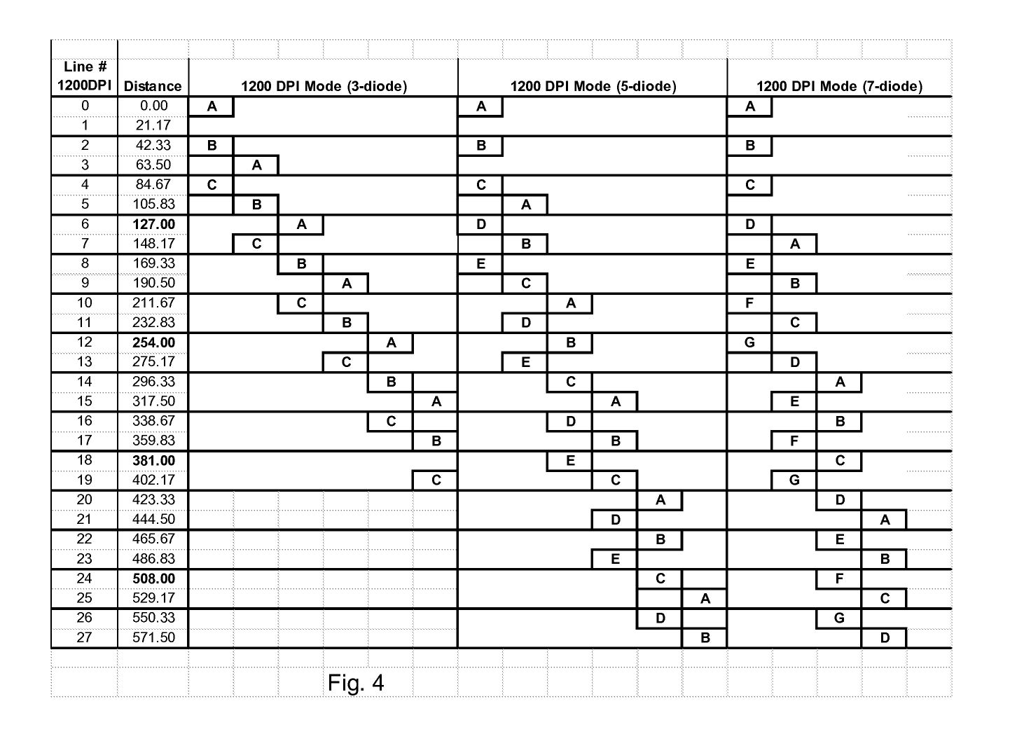

FIG. 4 illustrates the operation of printer 10 in three additional operating modes in accordance with an example embodiment. Each operating mode illustrated utilizes an interlacing scheme for impinging the photoconductive surface with laser beams 50. The effective scanning resolution is increased to 1200 dpi in the process direction. Each operating mode illustration utilizes a different number of laser diodes 71 during the print operation. As can be seen in FIG. 4, activating a greater number of diodes 71 for the print operation results in more scan lines impinging the surface of the photoconductive drum 40 with each mirror facet, thereby resulting in the print operation being completed faster than the time it takes for a print operation using a lesser number of diodes.

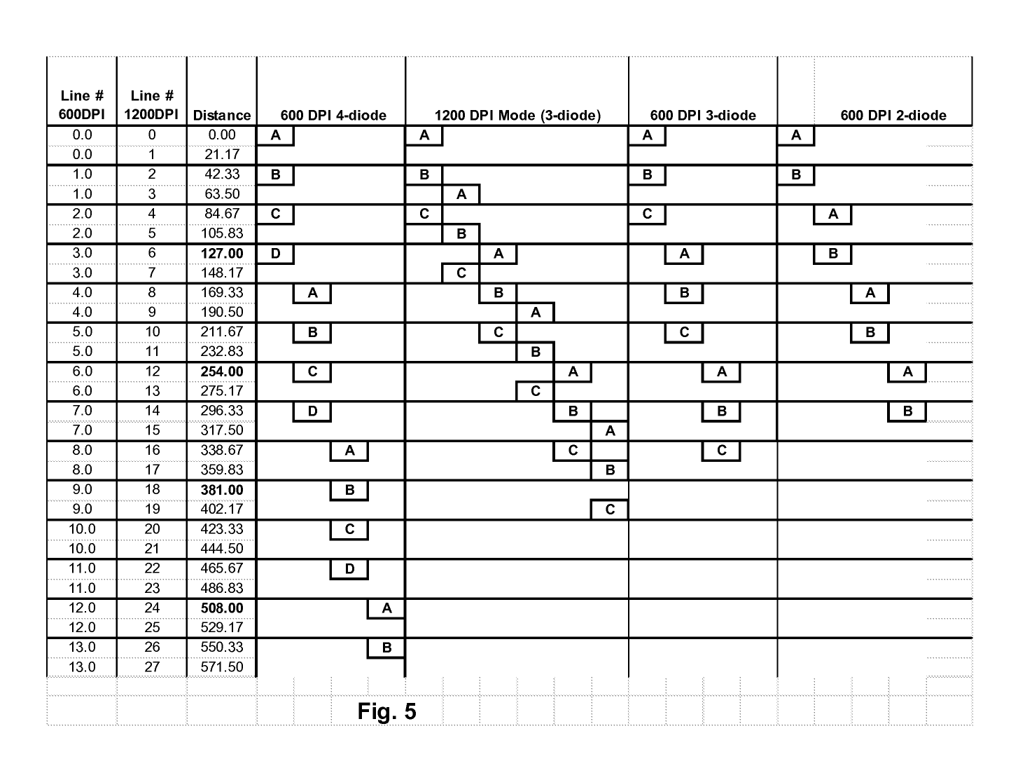

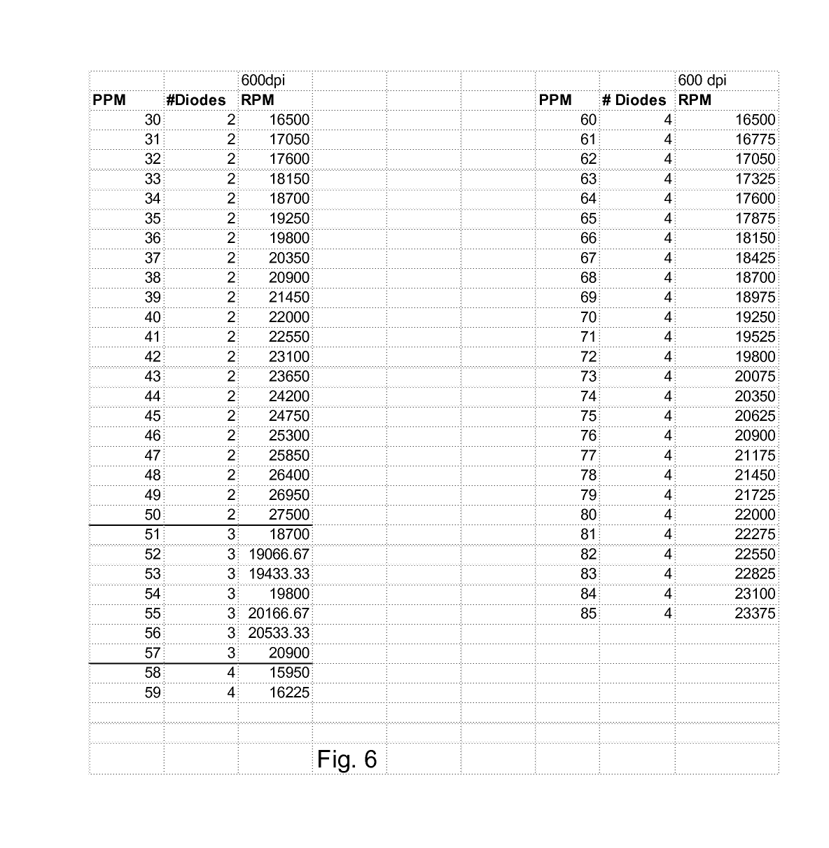

FIG. 5 illustrates the operation of printer 10 at both 600 dpi and 1200 dpi resolutions with different number of laser diodes 71 activated. FIG. 6 is a table showing, for each process speed between 30 ppm and 85 ppm, the number of laser diodes 71 that may be selected by controller 74 and the speed of the motor for polygon mirror 78. As can be seen, the speed of polygon mirror 78 remains within an acceptable range of speeds, between about 21 k rpm and about 35 k rpm. It is understood, however, that flexibility exists in the selection of the number of laser diodes 71 to be activated for a print operation to account for various user selections or device settings concerning a user's print operation.

It has been observed that example embodiments achieve a shorter time to first print (TTFP) and time to first copy (TTFC) when a greater number of laser diodes 71 are activated for a print operation. For a process speed of 70 ppm, for example, use of four laser diodes 71 for a print operation has been seen to provide TTFP/TTFC times of about four seconds and use of three laser diodes 71 has been seen to provide between about 5.5 seconds and about six seconds. Accordingly, controller 74 may select the number of laser diodes 71 for activation for a print operation based in part upon a user selection or printer setting of a TTFP/TTFC time, wherein the selection or setting of shorter TTFP/TTFC times may result in controller 74 selecting a larger number of laser diodes 71 for activation and the selection or setting of longer TTFP/TTFC times may cause controller 74 to select a smaller number thereof

It has been further observed that, at the same process speed and resolution, the printed image generated using a larger number of laser diodes 71 is darker than the printed image generated using a smaller number of laser diodes 71. This observation may be utilized to address printed images becoming darker when process speeds are slowed and different operating points being sometimes needed to compensate for the increased darkness.

Accordingly, controller 74 may be configured to provide sufficient compensation to account for a change in image darkness by selecting the number of laser diodes 71 for a print operation based upon process speed, wherein relatively slower process speeds may result in controller 74 selecting a lesser number of laser diodes 71 for activation than the number of laser diodes 71 that may be selected for a print operation at a faster process speed. In addition or in the alternative, controller 74 may select the number of laser diodes 71 for a print operation based in part upon a user selected darkness setting, wherein a relatively dark setting selected may result in controller 74 selecting a greater number of laser diodes 71 for activation than the number of laser diodes 71 that may be selected for a print operation in which a lighter image is selected.

FIG. 3 illustrates that for a fixed process speed, polygon mirror 78 must rotate at a higher speed when a relatively small number of laser diodes 71 are activated for a print operation than the mirror speed when a larger number of laser diodes 71 are so activated. A motor operating at higher speeds typically generates more noise than at slower speeds, and acoustic performance may be an important operating characteristic for some printing applications. Accordingly, controller 74 may be configured to select the number of laser diodes 71 for activation for a print operation based in part upon a desired level of acoustic performance by printer 10, wherein a greater number of laser diodes 71 may be activated for the print operation when less noise is desired (i.e., a “quiet mode” of operation) than the number of laser diodes 71 selected when noise level is less of a concern. An acoustic performance setting may be, for example, selected by a user or a default printer setting for printer 10.

The term “overscan” generally refers to a printhead unit 24, 26, 28, 30 having multiple scan lines containing imaging data being written on the location of the surface of a photoconductive drum. Overscanning may be used to improve the print quality of a printed image. Controller 74 may thus be configured to select a number of laser diodes 71 for activation as well as the speed of polygon mirror 78 during a print operation based in part upon a determination of the need to perform overscanning in generating the corresponding printed image.

Printhead unit 24 is described above as including a plurality of laser diodes 71, each of which generates a laser beam that is deflected from the facets 80 of polygon mirror 78 onto the surface of photoconductive drum 40 during a print operation. The particular angle at which a laser beam is incident upon the facet 80 of polygon mirror 78 in part determines the location of the beam's scan line on the surface of photoconductive drum 40. In circumstances in which less than all of the laser diodes 71 are activated for creating a latent image for a print operation, controller 74 may be configured to select the particular laser diodes 71 for activation based in part upon the location and orientation of each diode 71 relative to polygon mirror 78.

Further, in an example embodiment, a laser diode 71 that is unselected for activation in creating a latent image on the surface of photoconductive drum 40 during a print operation may be used to perform another function, such as a function at lower power than the level of laser power normally utilized in creating the latent image. For example, an unselected laser diode 71 may be used to provide an erase operation in which the surface of the photoconductive drum 40 is modified by passing one or more scan lines of a laser beam from an unselected laser diode 71 operating at reduced power. Accordingly, controller 74 may be configured to select less than all of the laser diodes 71 for use in creating the latent image on photoconductive drum 40, and use at least one unselected laser diode 71 to perform an erase operation or other operation at lower laser power levels. The benefit of erase operations is known as described in U.S. Pat. No. 6,356,726, assigned to the assignee of the present application, the content of which is incorporated by reference herein it its entirety.

The foregoing description of several methods and an embodiment of the invention have been presented for purposes of illustration. It is not intended to be exhaustive or to limit the invention to the precise steps and/or forms disclosed, and obviously many modifications and variations are possible in light of the above teaching. For example, the example embodiments described herein utilize a polygon mirror for deflecting the laser beams for creating scan lines of image data. In an alternative embodiment, a torsion or galvanometer oscillator is utilized for deflecting the laser beams.

It is intended that the scope of the invention be defined by the claims appended hereto.

What is claimed is:

1. An electrophotographic device, comprising:
a plurality of independently controllable light sources, each light source generating a light beam when activated;
a photoconductive surface operable at a plurality of image transfer rates;
a scanning device having one or more deflecting surfaces, the scanning device arranged to direct the light beams so as to sweep in at least one scan direction across the photoconductive surface such that, for each sweep, scan lines written by the light beams are spaced from one another on the photoconductive surface in a process direction that is nominally orthogonal to the scan direction by a predetermined beam scan spacing; and
a controller arranged to activate any number of the light sources for use during a print operation to write image data along scan lines on the photoconductive surface, wherein a rotational velocity of the scanning device is set and the number of the light sources is activated by the controller based upon at least one of a user selection and device setting.

2. The electrophotographic device of claim 1, wherein the controller activates less than all of the light sources for the print operation, the light sources activated being based in part upon a location of the light sources relative to the scanning device.

3. The electrophotographic device of claim 1, wherein the controller activates the number of light sources for the print operation based in part upon a user selected darkness setting of a to be printed image.

4. The electrophotographic device of claim 3, wherein the controller activates a first number of light sources for the print operation when the user selected darkness setting is for a relatively dark image and activates a second number of light sources for the print operation when the user selected darkness setting if for a light image, the first number of light sources being greater than the second number thereof

5. The electrophotographic device of claim 1, wherein the at least one of a user selection and device setting comprises an acoustic level setting for the electrophotographic device, and the controller activates the number of light sources for the print operation based in part upon the acoustic level setting.

6. The electrophotographic device of claim 5, wherein the controller activates a first number of light sources for the print operation when the acoustic level setting is for a relatively quiet operation of the electrophotographic device, and a second number of light sources when the acoustic level setting is for a relatively less quiet operation of the electrophotographic device, the first number of light sources being greater than the second number thereof

7. The electrophotographic device of claim 1, wherein a light source that is not activated is used to perform a function during the print operation at a power level that is less than a power level of the number of light sources that are activated for the print operation.

8. The electrophotographic device of claim 7, wherein the function comprises an erasure operation.

9. The electrophotographic device of claim 1, wherein the controller activates the number of light sources for the print operation to cause multiple scan lines to be written on the same location of the photoconductive surface.

10. The electrophotographic device of claim 1, wherein the number of light sources activated for the print operation is based upon a selected time to first print setting of the electrophotographic device.

11. The electrophotographic device of claim 10, wherein the controller activates a first number of diodes for the print operation when a relatively shorter time to first print is selected, and activates a second number of diodes for the print operation when a relatively longer time to first is selected, the first number being greater than the second number.

12. An imaging device, comprising:
a plurality of independently controllable light sources, each light source generating a light beam when activated;
a photoconductive surface operable at a plurality of image transfer rates;
a scanning device having one or more deflecting surfaces, the scanning device arranged to direct the light beams so as to sweep in at least one scan direction across a surface such that, for each sweep, scan lines written by the light beams are spaced from one another on the photoconductive surface in a process direction that is nominally orthogonal to the scan direction; and
a controller configured to selectively activate any number of the light sources for use during a print operation to write image data along scan lines on the photoconductive surface, wherein a rotational velocity of the scanning device is selected and the number of the light sources activated based upon at least one selected operating parameter for the imaging device.

13. The imaging device of claim 12, wherein the at least one selected operating parameter comprises a selection of a darkness or lightness setting for the print operation.

14. The imaging device of claim 13, wherein the controller selects a first number of the light sources for activation when the darkness or lightness setting for the print operation is relatively dark and selects a second number of the light sources for activation when the darkness or lightness setting for the print operation is relatively light, the first number being greater than the second number.

15. The imaging device of claim 12, wherein the at least one operating parameter comprises a noise level setting of the imaging device during the print operation.

16. The imaging device of claim 15, wherein the controller selects a first number of the light sources for activation when the noise level setting selected is at a first noise level and selects a second number of the light sources for activation when the noise level setting selected is at a second noise level greater than the first noise level, the first number being greater than the second number.

17. The imaging device of claim 12, wherein the number of light sources activated for the print operation is less than a total number of light sources available, and a light source not selected for activation is used during the print operation to provide a light beam having a power level that is less than a power level of the light beams generated by the light sources that are activated for the print operation.

18. The imaging device of claim 12, wherein the number of light sources activated for the print operation is less than a total number of light sources available and are selected based upon a location of the light sources relative to the scanning device.

19. The imaging device of claim 12, wherein the at least one operating parameter comprises a time to first print setting for the imaging device.
